(19) United States
(12) Patent Application Publication
(10) Pub. No.: US 2021/0102034 A1
(43) Pub. Date: Apr. 8, 2021

(54) MANUFACTURING METHOD OF CONTINUOUS TRANSPARENT POLYIMIDE FILM FOR DISPLAY

(71) Applicant: TAIMIDE TECHNOLOGY INCORPORATION, Hsinchu Hsien (TW)

(72) Inventors: YI-HSUEH HO, Hsinchu Hsien (TW); YUN-HSIANG CHANG, Hsinchu Hsien (TW); YI-CHIA HUANG, Hsinchu Hsien (TW); PAUL S.C. WU, Hsinchu Hsien (TW)

(21) Appl. No.: 17/009,802

(22) Filed: Sep. 2, 2020

(30) Foreign Application Priority Data
Oct. 3, 2019 (TW) 108135863

(51) Int. Cl. C08J 5/18; C08G 73/10; C09D 179/08

(52) U.S. Cl. CPC C08J 5/18; C08G 73/1067; C08J 2379/08; C08G 73/1078; C09D 179/08; C08G 73/1082

(57) ABSTRACT

A manufacturing method of a continuous transparent polyimide film for a display includes the following steps providing a roll-to-roll polyimide film; providing a polyimide precursor, which is coated on the polyimide film; and baking the polyimide precursor at a baking temperature that is at least 20° C. higher than a glass transition temperature of the transparent polyimide film, such that the transparent polyimide film has an optical transmittance of greater than 85%, a chromaticity (b*) of less than 2, and a standard deviation of three axial refractive indices of the transparent polyimide film is less than 0.0012. Thus, the transparent polyimide film with reduced light leakage can be obtained.

### CROSS-REFERENCE TO RELATED APPLICATION

This non-provisional application claims priority under 35 U.S.C. § 119(a) on Patent Application No(s). 108135863 filed in Taiwan, R.O.C. on Oct. 3, 2019, the entire contents of which are hereby incorporated by reference.

### BACKGROUND OF THE INVENTION

### 1. Field of the Invention

The present invention relates to a manufacturing method of a continuous transparent polyimide film for a display, and in particular to a transparent polyimide film having a lower standard deviation of three axial refractive indices to make the transparent polyimide film have less light leakage.

### 2. Description of the Related Art

The polyimide film has excellent heat resistance and mechanical properties, so it is often utilized in flexible circuit board applications using high temperature processes. In addition, because of the good bending resistance and optical characteristics, the transparent polyimide film is one of the few materials that can meet the requirements of optical characteristics and heat resistance in the field of monitor for electronic display in recent years.

Please refer to FIG. 1, which is a schematic view of the conventional transparent polyimide film used in touch panel for display, wherein the transparent polyimide film 10 is disposed between the polarizing plate 12 and the light source 14. The transparent polyimide film 10 is manufactured in a discontinuous manner, and has a small standard deviation of three axial refractive indices, thereby achieving lower light leakage. However, the production speed of the transparent polyimide film 10 is slow and the production cost thereof is high. Therefore, some people in the industry consider whether it is possible to manufacture the transparent polyimide film for display in a continuous manner so as to increase production speed and reduce the cost. However, the transparent polyimide film manufactured in a continuous manner will have a large difference between the refractive indices of the film surface in the x axis direction and the y axis direction due to the biaxial stretching process, resulting in light leakage when being applied to the touch panel of the display, which is a problem to be overcome in the industry.

### BRIEF SUMMARY OF THE INVENTION

The present invention provides a manufacturing method of a continuous transparent polyimide film for a display, which includes the following steps: providing a polyimide film set on a continuous process; providing a transparent polyimide precursor coated on the polyimide film; and baking the transparent polyimide precursor at a baking temperature to form a transparent polyimide film with an optical transmittance of greater than 85% and a chromaticity (b*) of less than 2, wherein the baking temperature is at least 20° C. higher than a glass transition temperature of the transparent polyimide film, and a standard deviation of three axial refractive indices (nₓ, n_{y}, n_{z}) of the transparent polyimide film is less than 0.00120.

Therefore, the production speed of the transparent polyimide film can be increased to reduce the cost, and the transparent polyimide film has a small standard deviation of three axial refractive indices and low light leakage as well.

### BRIEF DESCRIPTION OF THE DRAWINGS

FIG. 1 is a schematic view of the conventional transparent polyimide film used in a touch panel for a display.

FIG. 2 is a schematic view showing a manufacturing method of a continuous transparent polyimide film for a display according to the present invention.

FIG. 3 shows a transparent polyimide film manufactured according to the present invention.

FIG. 4 is a flow chart showing a manufacturing method of a continuous transparent polyimide film for a display according to the present invention.

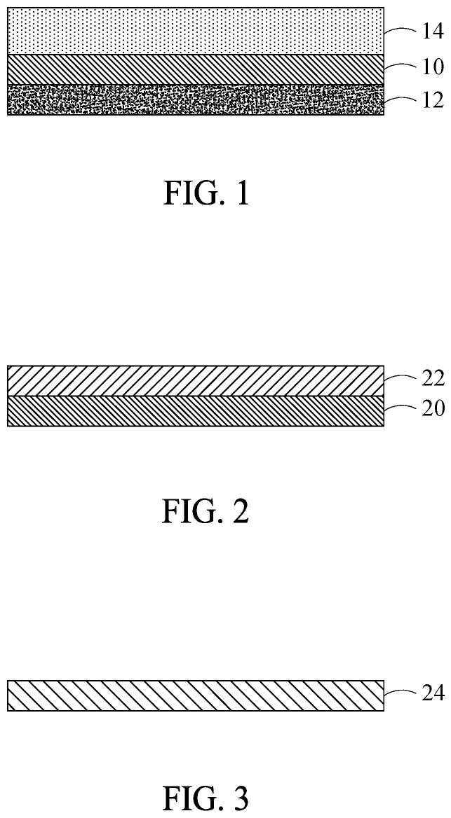

### DETAILED DESCRIPTION OF THE INVENTION

To facilitate understanding of the object, characteristics and effects of this present disclosure, embodiments together with the attached drawings for the detailed description of the present disclosure are provided.

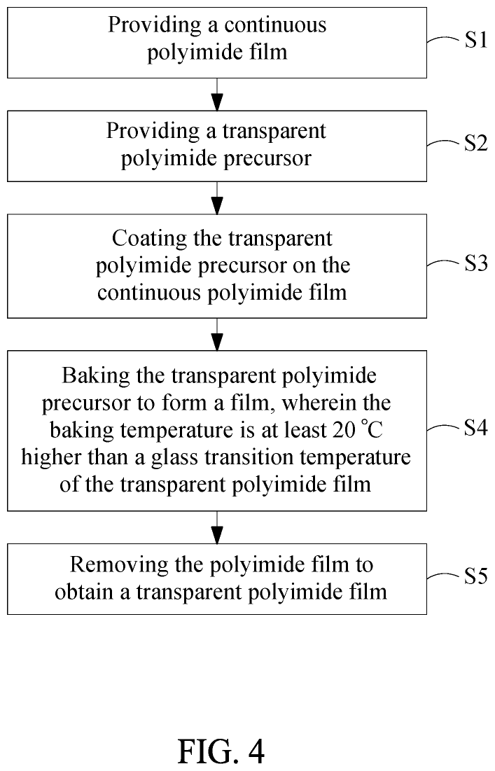

With reference to FIGS. 2-4, the present invention provides a manufacturing method of a continuous transparent polyimide film for a display, which includes the following steps.

Providing a polyimide film 20 for a continuous process (S1); and providing a transparent polyimide precursor 22 (S2), which is coated on the polyimide film 20 (S3), wherein the polyimide precursor 22 may be a polyamic acid solution or a polyimide solution.

Baking the polyimide precursor 22 (S4). The baking temperature has to be at least 20° C. higher than a glass transition temperature of the transparent polyimide film 24. After film formation of the transparent polyimide film 24, the polyimide film 20 is removed (S5) to obtain the transparent polyimide film 24 having an optical transmittance of greater than 85% and a chromaticity (b*) of less than 2. The standard deviation of the three axial refractive indices of the transparent polyimide film 24 is less than 0.00120, which results in low light leakage.

Because the present invention coats the transparent polyimide precursor 22 on the polyimide film 20, it will not be affected by the biaxial extension when baking to form the transparent polyimide 24, so the difference between the refractive indices of the film surface in the x-axis direction and the film surface in the y-axis direction won't be too large. Also, the baking temperature is higher than the glass transition temperature of the transparent polyimide film 14 by more than 20 degrees such that the polyimide molecular segments can be rearranged to reduce the difference between the refractive indices of the film surface in the z-axis, x-axis and y-axis directions, thereby reducing the light leakage.

The polyimide precursor may be a polyamic acid solution or a polyimide solution.

The inherent viscosity (intrinsic viscosity) of the polyimide precursor 22 needs to be greater than 1 to ensure that the polyimide film has a certain degree of mechanical properties. In addition, the polyimide precursor is obtained by the polymerization of a diamine and a dianhydride, wherein the diamine is composed of 4,4′-bis(4-aminophenoxy) diphenyl sulfone (pBAPS), 4,4′-bis(3-aminophenoxy) diphenyl sulfone (mBAPS), 1,3-bis(3-aminophenoxy)benzene (APB-N), 2,2-bis[4-(4-aminophenoxy)phenyl]-1,1,1,3,3,3-hexafluoropropane (HFBAPP), 4,4′-diaminodiphenyl sulfone (44DDS), 3,3′-diaminodiphenyl sulfone (33DDS), 2,2′-di(trifluoromethyl)benzidine (TFMB), Bicyclo[2.2.1]heptane dimethylamine (NBDA), 2,2′-bis(trifluoromethyl)-4,4′-diaminophenyl ether (6FODA), 2,2-bis(3-amino-4-hydroxyphenyl) hexafluoropropane (6FAP), 2,2-bis(4-aminophenyl) hexafluoropropane (Bis-A-AF), 4,4′-[1,4-phenyl bis(oxygen)]bis[3-(trifluoromethyl)aniline] (FAPB), 5(6)-amino-1-(4-aminophenyl)-1,3,3-trimethylindane (TMDA), 9,9-bis(4-aminophenyl) fluorene (BAFL), m-phenylenediamine (mPDA) or a combination thereof.

The dianhydride may be composed of 4,4-hexafluoroisopropylphthalic anhydride (6FDA), bisphenol A diether dianhydride (BPADA), 3,3′,4,4′-biphenyltetracarboxylic dianhydride (BPDA), 3,3,4,4-diphenyl sulfone tetracarboxylic dianhydride (DSDA), 4,4′-oxydiphthalic anhydride (ODPA), 3,3′,4,4′-diphenyl ketonetetracarboxylic dianhydride (BTDA), 1,2,3,4-cyclobutanetetracarboxylic dianhydride (CBDA), 1,2,4,5-cyclohexanetetracarboxylic dianhydride (HPMDA), bicyclic[2.2.2] oct-7-ene-2,3,5,6-tetracarboxylic dianhydride (BTA), hexahydro-4,8-ethano-1H, 3H-benzo[1,2-c:4,5-c′]difuran-1,3,5,7-tetrone (BODA), 2,3,3′,4′-biphenyltetracarboxylic dianhydride (α-BPDA) or a combination thereof. In addition, the transparent polyimide film has a thickness ranging from 5 to 25 um.

### Example 1

Manufacturing of Polyimide Precursor

4.933 kg of mBAPS (0.0114 mol) was added into 30 kg of N,N-dimethylacetamide (DMAc). After all the mBAPS was dissolved, 5.067 kg of 6FDA (0.0114 mol) was slowly added under the controlled temperature of 25° C. Stirring was performed for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 300° C., a composite film of the transparent polyimide film and the polyimide film was obtained. The transparent polyimide was removed to obtain the transparent polyimide film.

### Example 2

Manufacturing of Polyimide Precursor

4.538 kg of mBAPS (0.0105 mol) was added into 30 kg of N,N-dimethylacetamide (DMAc). After all the mBAPS was dissolved, 5.434 kg of 6FDA (0.0104 mol) was slowly added under the controlled temperature of 25° C. Stirring was performed for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 260° C., a composite film of the transparent polyimide film and the polyimide film was obtained. The transparent polyimide was removed to obtain the transparent polyimide film.

### Example 3

Manufacturing of Polyimide Precursor

2.932 kg of pBAPS (0.0068 mol) was added into 20 kg of N,N-dimethylacetamide (DMAc). After all the pBAPS was dissolved, 1.807 kg of 6FDA (0.0041 mol) was slowly added. 1.046 kg of NBDA and 10 kg of DMAc were evenly mixed and then slowly poured into the above mixture of pBAPS and 6FDA. Afterwards, 4.216 kg of 6FDA was slowly added and stirred for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 290° C., a composite film of the transparent polyimide film and the polyimide film was obtained. The transparent polyimide was removed to obtain the transparent polyimide film.

### Comparative Example 1

Manufacturing of Polyamic Acid

4.933 kg of mBAPS (0.0114 mol) was added into 30 kg of N,N-dimethylacetamide (DMAc). After all the mBAPS was dissolved, 5.067 kg of 6FDA (0.0114 mol) was slowly added under the controlled temperature of 25° C. Stirring was performed for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 260° C., a composite film of the transparent polyimide film and the polyimide film was obtained. The transparent polyimide was removed to obtain the transparent polyimide film.

### Comparative Example 2

Manufacturing of Polyimide Precursor

4.538 kg of mBAPS (0.0105 mol) was added into 30 kg of N,N-dimethylacetamide (DMAc). After all the mBAPS was dissolved, 5.434 kg of 6FDA (0.0104 mol) was slowly added under the controlled temperature of 25° C. Stirring was performed for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 220° C., a composite film of the transparent polyimide film and the polyimide film was obtained. The transparent polyimide was removed to obtain the transparent polyimide film.

### Comparative Example 3

Manufacturing of Polyimide Precursor

2.932 kg of pBAPS (0.0068 mol) was added into 20 kg of N,N-dimethylacetamide (DMAc). After all the pBAPS was dissolved, 1.807 kg of 6FDA (0.0041 mol) was slowly added. 1.046 kg of NBDA and 10 kg of DMAc were evenly mixed and then slowly poured into the above mixture of pBAPS and 6FDA. Afterwards, 4.216 kg of 6FDA was slowly added and stirred for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor added with an appropriate amount of acetic anhydride and 3-picoline was coated on the polyimide film by a continuous process. After baking at a temperature not exceeding 270° C., a composite film of the transparent polyimide film and the polyimide film was obtained. The transparent polyimide was removed to obtain the transparent polyimide film.

### Comparative Example 4

Manufacturing of Polyamic Acid

24.665 kg of mBAPS (0.057 mol) was added into 150 kg of N,N-dimethylacetamide (DMAc). After all the mBAPS was dissolved, 25.335 kg of 6FDA (0.057 mol) was slowly added under the controlled temperature of 25° C. Stirring was performed for a certain period of time to dissolve and react, and the temperature of the solution was maintained at 25° C. Finally, the polyimide precursor with a solid content of 25% was obtained.

Manufacturing of Transparent Polyimide Film

The above-mentioned polyimide precursor was added with an appropriate amount of acetic anhydride and 3-picoline. After baking at a temperature not exceeding 260° C. by a continuous process, a transparent polyimide film was obtained.

The optical properties of the transparent polyimide films obtained in the following examples were measured using the following methods:

Refractive index: AXOMETRICS polarization measuring equipment was used for measurement.

Chromaticity b*: Model NE-4000 instrument manufactured by Nippon Denshoku was used for measurement according to ASTM E313 standard.

Light transmittance: Model NDH-2000N instrument manufactured by Nippon Denshoku was used for measurement according to ISO 14782 standard.

Test results of the polymerization method of Examples and Comparative Examples

| | Poly- | | | | | |
|---|---|---|---|---|---|---|
| | imide | | | | Tg | Baking |
| | carrier | Dianhydride | Diamine | | ° C. | Temp. |
| Ex. 1 | w | 6FDA | mBAPS | — | 241 | 300 |
| Ex. 2 | w | BPADA | mBAPS | — | 200 | 260 |
| Ex. 3 | w | 6FDA | NBDA₅₀ | pBAPS₅₀ | 268 | 290 |
| Comp. | w | 6FDA | mBAPS | — | 241 | 260 |
| Ex. 1 | | | | | | |
| Comp. | w | BPADA | mBAPS | — | 200 | 220 |
| Ex. 2 | | | | | | |
| Comp. | w | 6FDA | NBDA | pBAPS | 268 | 270 |
| Ex. 3 | | | | | | |
| Comp. | w/o | 6FDA | mBAPS | — | 241 | 260 |
| Ex. 4 | | | | | | |

| | Refractive index | | | | | TT |
|---|---|---|---|---|---|---|
| | nₓ | n_{y} | n_{z} | St. Dev. | b* | % |
| Ex. 1 | 1.620161 | 1.620153 | 1.618186 | 0.00114 | 1 | 89 |
| Ex. 2 | 1.661753 | 1.661759 | 1.660988 | 0.00044 | 0.9 | 88 |
| Ex. 3 | 1.589423 | 1.589419 | 1.587397 | 0.00117 | 1.7 | 89 |
| Comp. | 1.618292 | 1.618291 | 1.615317 | 0.00172 | 1 | 89 |
| Ex. 1 | | | | | | |
| Comp. | 1.661245 | 1.661238 | 1.659101 | 0.00124 | 0.9 | 88 |
| Ex. 2 | | | | | | |
| Comp. | 1.589495 | 1.589499 | 1.587406 | 0.00121 | 1.5 | 89 |
| Ex. 3 | | | | | | |
| Comp. | 1.618392 | 1.616601 | 1.615107 | 0.00165 | 1.1 | 89 |
| Ex. 4 | | | | | | |

The contents of the above examples are provided for illustrating the present invention in detail. However, those examples are for illustration only and are not intended to limit the present invention. People having ordinary skill in the art should understand that various changes or modifications made to the present invention without departing from the scope defined by the appended claims still fall within a part of the present invention.

What is claimed is:

1. A manufacturing method of a continuous transparent polyimide film for a display, comprising the following steps:
providing a polyimide film set on a continuous process;
providing a transparent polyimide precursor coated on the polyimide film; and
baking the transparent polyimide precursor at a baking temperature from 200° C. to 300° C. to form a transparent polyimide film with an optical transmittance of greater than 85% and a chromaticity (b*) of less than 2, wherein the baking temperature is at least 20° C. higher than a glass transition temperature of the transparent polyimide film, and a standard deviation of three axial refractive indices (nₓ, n_{y}, n_{z}) of the transparent polyimide film is less than 0.00120.

2. The manufacturing method of continuous transparent polyimide film for display of claim 1, wherein the transparent polyimide precursor is a transparent polyamic acid solution or a transparent polyimide solution.

3. The manufacturing method of continuous transparent polyimide film for display of claim 1, wherein the transparent polyimide precursor has an inherent viscosity (intrinsic viscosity) of greater than 1.

4. The manufacturing method of continuous transparent polyimide film for display of claim 1, wherein the transparent polyimide precursor is obtained by the polymerization of a diamine and a dianhydride, wherein the diamine is composed of 4,4′-bis(4-aminophenoxy) diphenyl sulfone (pBAPS), 4,4′-bis(3-aminophenoxy) diphenyl sulfone (mBAPS), 1,3-bis(3-aminophenoxy)benzene (APB-N), 2,2-bis[4-(4-aminophenoxy)phenyl]-1,1,1,3,3,3-hexafluoropropane (HFBAPP), 4,4′-diaminodiphenyl sulfone (44DDS), 3,3′-diaminodiphenyl sulfone (33DDS), 2,2′-di(trifluoromethyl)benzidine (TFMB), Bicyclo[2.2.1]heptane dimethylamine (NBDA), 2,2′-bis(trifluoromethyl)-4,4′-diaminophenyl ether (6FODA), 2,2-bis(3-amino-4-hydroxyphenyl) hexafluoropropane (6FAP), 2,2-bis(4-aminophenyl) hexafluoropropane (Bis-A-AF), 4,4′-[1,4-phenyl bis(oxygen)]bis[3-(trifluoromethyl)aniline] (FAPB), 5(6)-amino-1-(4-aminophenyl)-1,3,3-trimethylindane (TMDA), 9,9-bis(4-aminophenyl) fluorene (BAFL), m-phenylenediamine (mPDA) or a combination thereof.

5. The manufacturing method of continuous transparent polyimide film for display of claim 1, wherein the transparent polyimide precursor is obtained by the polymerization of a diamine and a dianhydride, wherein the dianhydride is composed of 4,4-hexafluoroisopropylphthalic anhydride (6FDA), bisphenol A diether dianhydride (BPADA), 3,3′,4,4′-biphenyltetracarboxylic dianhydride (BPDA), 3,3,4,4-diphenyl sulfone tetracarboxylic dianhydride (DSDA), 4,4′-oxydiphthalic anhydride (ODPA), 3,3′,4,4′-diphenyl ketonetetracarboxylic dianhydride (BTDA), 1,2,3,4-cyclobutanetetracarboxylic dianhydride (CBDA), 1,2,4,5-cyclohexanetetracarboxylic dianhydride (HPMDA), bicyclic[2.2.2] oct-7-ene-2,3,5,6-tetracarboxylic dianhydride (BTA), hexahydro-4,8-ethano-1H, 3H-benzo[1,2-c:4,5-c′]difuran-1,3,5,7-tetrone (BODA), 2,3,3′,4′-biphenyltetracarboxylic dianhydride (α-BPDA) or a combination thereof.

6. The manufacturing method of continuous transparent polyimide film for display of claim 1, wherein the transparent polyimide film has a thickness ranging from 5 to 25 um.
